(19) United States
(12) Patent Application Publication
(10) Pub. No.: US 2024/0361034 A1
(43) Pub. Date: Oct. 31, 2024

(54) AIRFLOW CONTROL SYSTEM

(71) Applicant: Panasonic Intellectual Property Management Co., Ltd., Osaka (JP)

(72) Inventors: Hayato TAKAHASHI, Hyogo (JP); Nobuaki YABUNOUCHI, Kyoto (JP)

(73) Assignee: Panasonic Intellectual Property Management Co., Ltd., Osaka (JP)

(21) Appl. No.: 18/290,293

(22) PCT Filed: Mar. 15, 2022
(86) PCT No.: PCT/JP2022/011613

§ 371 Date: Nov. 11, 2023

(30) Foreign Application Priority Data
May 19, 2021 (JP) 2021-084846

(51) Int. Cl. F24F 13/08; F04D 19/00; F04D 29/54; F24F 7/007

(52) U.S. Cl. CPC F24F 13/08; F04D 19/002; F04D 29/542; F24F 7/007

(57) ABSTRACT

In an airflow control system, a tube body includes an inflow port and an outflow port. A first rectifying device is located between a fan and the outflow port in an axial direction of the fan and is configured to redirect an airflow which is swirling. A second rectifying device is located between the first rectifying device and the outflow port in the axial direction and is configured to align the direction of the airflow with a direction along the axial direction. The first rectifying device includes a tube part which is cylindrical and fins. Each of the fins has an arc shape. The fins protrude from an inner circumferential surface of the tube part toward a central axis of the tube part and are aligned in a direction along an inner circumference of the tube part. The second rectifying device includes flow paths along the axial direction.

### TECHNICAL FIELD

The present disclosure relates to airflow control systems and specifically relates to an airflow control system including a fan.

### BACKGROUND ART

Patent Literature 1 discloses a fluid conveying device configured to: spurt a fluid, such as a gas or a liquid, to be conveyed from spurting parts into a space; and locally convey the fluid to a target part away from the spurting parts while suppressing diffusion of the fluid.

The fluid conveying device disclosed in Patent Literature 1 includes: a first exhaust nozzle configured to spout a fluid to be conveyed on the conditions used as a laminar flow jet stream; and a second exhaust nozzle surrounding the peripheral part of the first exhaust nozzle and configured to spout a second fluid as an annular jet stream. It is described that when the velocity of the fluid to be conveyed and spouted from the first exhaust nozzle is set to Um and the velocity of the second fluid spouted from the second exhaust nozzle is set to Ua, it is preferable that Ua/Um≤1 and when Ua/Um=0.75, the velocity ratio is optimal.

When for the purpose of downsizing the airflow control system, one fan is used to form an airflow, the airflow control system has a flow velocity higher on an outer side than on an inner side and thus difficultly suppresses the airflow from diffusing.

### CITATION LIST

### Patent Literature

Patent Literature 1: WO 2014/017208 A1

### SUMMARY OF INVENTION

It is an object of the present disclosure to provide an airflow control system configured to suppress an airflow from diffusing.

An airflow control system according to an aspect of the present disclosure includes a tube body, a fan, a first rectifying device, and a second rectifying device. The tube body is cylindrical. The tube body has a first end provided with an inflow port for gas and a second end provided with an outflow port for gas. The fan is disposed on an inner side of the tube body. The first rectifying device is located between the fan and the outflow port in an axial direction of the fan and is configured to redirect an airflow which is swirling. The second rectifying device is located between the first rectifying device and the outflow port in the axial direction of the fan and is configured to align the direction of the airflow with a direction along the axial direction of the fan. The first rectifying device includes a tube part which is cylindrical and a plurality of fins. Each of the plurality of fins has an arc shape. The plurality of fins protrude from an inner circumferential surface of the tube part toward a central axis of the tube part, the plurality of fins being aligned in a direction along an inner circumference of the tube part. The second rectifying device includes a plurality of flow paths along the axial direction of the fan.

### BRIEF DESCRIPTION OF DRAWINGS

FIG. 1 is an exploded perspective view of an airflow control system according to a first embodiment;

FIG. 2 is a sectional view of the airflow control system;

FIG. 3A is a plan view of a fan in the airflow control system;

FIG. 3B is a plan view of a first rectifying device in the airflow control system;

FIG. 3C is a plan view of a second rectifying device in the airflow control system;

FIG. 4 is a perspective view of the airflow control system;

FIG. 5 is an illustrative view of a function of the first rectifying device in the airflow control system;

FIG. 6A is a view of a flow velocity distribution of the airflow control system;

FIG. 6B is a view of a flow velocity distribution of an airflow control system according to a comparative example;

FIG. 7 is an exploded perspective view of an airflow control system according to a second embodiment;

FIG. 8 is a sectional view of the airflow control system according to the second embodiment;

FIG. 9 is a view of a flow velocity distribution of the airflow control system according to the second embodiment;

FIG. 10 is a sectional view of an airflow control system according to a third embodiment; and

FIG. 11 is a sectional view of an airflow control system according to a fourth embodiment.

### DESCRIPTION OF EMBODIMENTS

Figures described below in first to fourth embodiments and the like are schematic views, and therefore, the ratio of sizes and the ratio of thicknesses of components in the drawings do not necessarily reflect actual dimensional ratios.

### First Embodiment

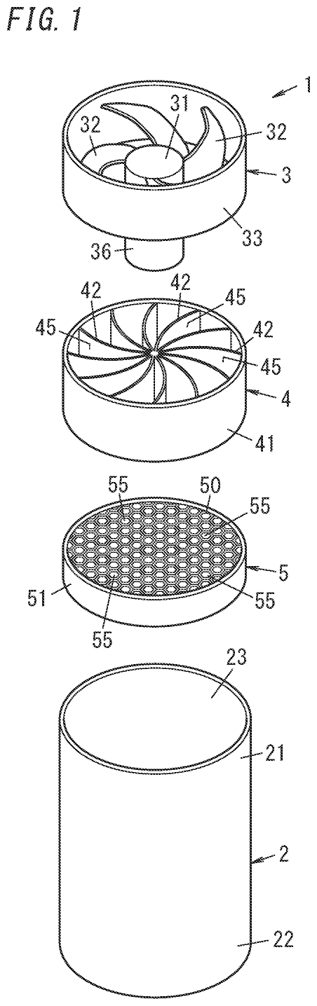

With reference to FIGS. 1 to 5, an airflow control system 1 according to a first embodiment will be described below.

### (1) Overview

The airflow control system 1 is used, for example, for space zoning in a facility. The space zoning is zoning of air and means creating an air environment of a specific area in a target space without forming a physical wall such as a wall or a partition.

An airflow spouted from the airflow control system 1 into the target space is a jet stream and is a directionality airflow having a property of straightness. The airflow is a flow of air. The facility is, for example, an office building. The target space is, for example, a free address office in the office building. The target space is not limited to the free address office but may be a space and the like of, for example, a meeting room.

Examples of the facility include hotels, hospitals, education facilities, detached dwelling houses, multiple dwelling houses (dwelling units, common areas), retail establishments, commercial facilities, art museums, and museums in addition to the office building. Moreover, the facility is not limited to a building but may be premises including a building and its land, and examples of the premises include factories, parks, play facilities, theme parks, airports, railroad stations, and domed ballparks.

### (2) Details

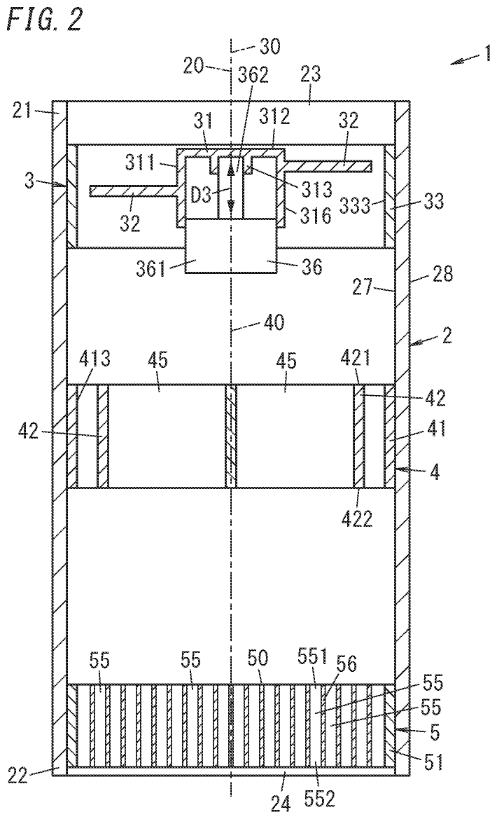

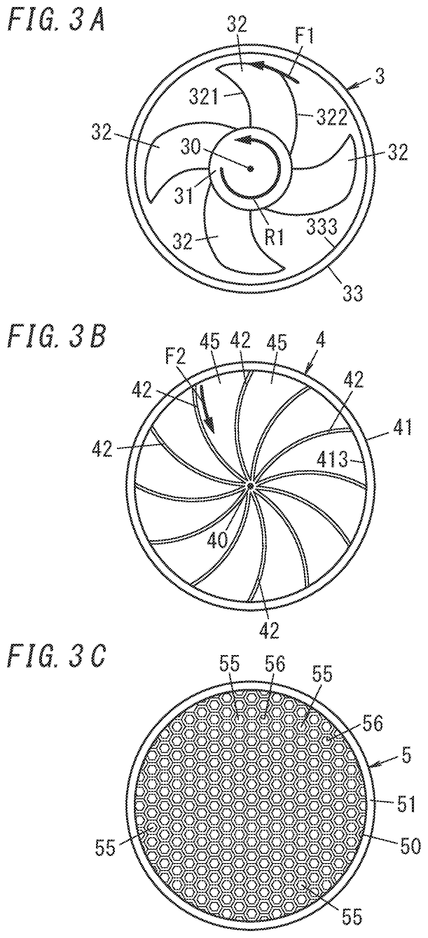

As shown in FIGS. 1 and 2, the airflow control system 1 includes a tube body 2, a fan 3, a first rectifying device 4, and a second rectifying device 5. The tube body 2 is cylindrical. The tube body 2 has a first end 21 provided with an inflow port 23 for gas and a second end 22 provided with an outflow port 24 for gas (see FIG. 2). The fan 3 is disposed on an inner side of the tube body 2. The first rectifying device 4 is located between the fan 3 and the outflow port 24 in an axial direction D3 (see FIG. 2) of the fan 3 and redirects an airflow F1 (see FIG. 3A) which is swirling. The second rectifying device 5 is located between the first rectifying device 4 and the outflow port 24 in the axial direction D3 and aligns the direction of the airflow with a direction along the axial direction D3. The first rectifying device 4 includes a tube part 41 which is cylindrical and a plurality of fins (stator vanes) 42. When viewed in the axial direction D3, each of the plurality of fins 42 has an arc shape as shown in FIG. 3B. The plurality of fins 42 protrude from an inner circumferential surface 413 of the tube part 41 toward a central axis 40 of the tube part 41 and are aligned in a direction along an inner circumference of the tube part 41. As shown in FIG. 2, the second rectifying device 5 has a plurality of flow paths 55 along the axial direction D3.

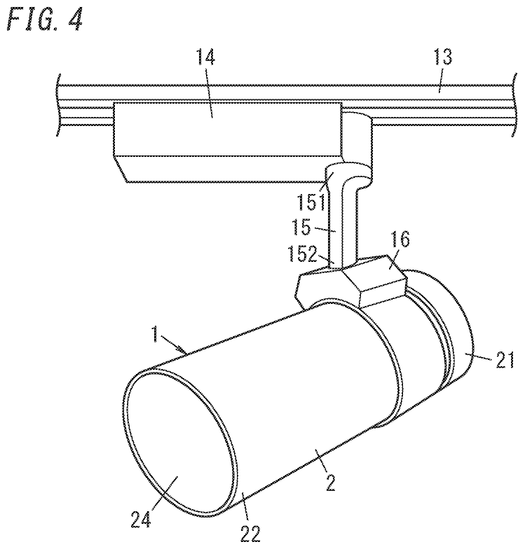

As shown in FIG. 4, the airflow control system 1 is attached to, for example, a wiring duct 13 provided to a ceiling. The airflow control system 1 includes an attachment device 14, an arm 15, and a coupling device 16. The attachment device 14 is slidably attached to the wiring duct 13. The arm 15 has a first end 151 and a second end 152. In the case of the arm 15, the first end 151 of the arm 15 is coupled to the attachment device 14. The coupling device 16 couples the second end 152 of the arm 15 to the tube body 2. Attaching the attachment device 14 to the wiring duct 13 electrically connects the airflow control system 1 to an alternating-current power supply connected to the wiring duct 13. The airflow control system 1 further includes a power supply circuit, a drive circuit, and a control device. The power supply circuit converts an alternating-current voltage from the alternating-current power supply into a direct-current voltage which is predetermined, and the power supply circuit outputs the direct-current voltage. The drive circuit receives the direct-current voltage output from the power supply circuit to drive a motor 36 (see FIG. 2) of the fan 3. The power supply circuit, the drive circuit, and the control device are housed in a housing of the attachment device 14. The arm 15 and the coupling device 16 each have a space into which an electric wire connected to the drive circuit is to be inserted.

The control device includes a computer system. The computer system may include a processor and memory as principal hardware components thereof. The processor executes a program stored in the memory of the computer system, thereby implementing a function as the control device. The program may be stored in advance in the memory of the computer system. Alternatively, the program may also be downloaded over a telecommunications network or be distributed after having been recorded in some non-transitory storage medium such as a memory card, an optical disc, or a hard disk drive, any of which is readable for the computer system. The processor of the computer system includes one or a plurality of electronic circuits including a semiconductor integrated circuit (IC) or large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. The plurality of electronic circuits may be collected on one chip or may be distributed on a plurality of chips. The plurality of chips may be collected in one device or may be distributed in a plurality of devices. The computer system as used herein includes a microcontroller including one or more processors and one or more memory elements. Thus, the microcontroller also includes one or a plurality of electronic circuits including a semiconductor integrated circuit or a large-scale integrated circuit.

As shown in FIGS. 1 and 2, the tube body 2 is cylindrical. The tube body 2 has the first end 21 and the second end 22, the first end 21 is provided with the inflow port 23 for gas, and the second end 22 is provided with the outflow port 24 for gas. A material for the tube body 2 is, for example, but not limited to, metal or a resin. As shown in FIG. 2, the tube body 2 has an inner circumferential surface (inner side surface) 27 and an outer circumferential surface (outer side surface) 28 on an opposite side from the inner circumferential surface 27.

The fan 3 blows air flowing into the inflow port 23 of the tube body 2 toward the outflow port 24 of the tube body 2. The fan 3 is an electrically driven axial-flow fan rotatable around a rotation central axis 30 (see FIG. 2) of a rotor 31 which the fan 3 includes. The air volume of the fan 3 is, for example, 50 m³/h to 300 m³/h. The fan 3 is configured to move air flowing into a fan housing 33 while helically rotating the air around the rotor 31 to cause the air to flow to a downstream side. The “downstream side” means a downstream side viewed in a direction in which the air flows.

As shown in FIG. 2, the fan 3 is disposed on the inner side of the tube body 2. The fan 3 is disposed closer to the first end 21 than to the second end 22 of the tube body 2 in an axial direction of the tube body 2. In the axial direction of the tube body 2, a distance between the fan 3 and the inflow port 23 is shorter than a distance between the fan 3 and the outflow port 24.

As shown in FIGS. 1 and 2, the fan 3 includes the rotor (hub) 31, a plurality of (e.g., four) blades (rotary vanes) 32, a fan housing 33, a motor 36, a motor attachment, and a plurality of (e.g., three) beams. A material for the fan 3 is, for example, a resin or metal.

The rotor 31 is rotatable around the rotation central axis 30. When viewed in the axial direction D3 of the fan 3, an outer edge of the rotor 31 has a circular shape. The rotor 31 is disposed on the inner side of the tube body 2 and coaxially with the tube body 2. Saying that “the rotor 31 is disposed on the inner side of the tube body 2 and coaxially with the tube body 2” means that the rotor 31 is disposed such that the rotation central axis 30 of the rotor 31 coincides with a central axis 20 of the tube body 2 as shown in FIG. 2. In the axial direction D3 of the fan 3, the rotor 31 has a length shorter than a length of the tube body 2. The axial direction D3 of the fan 3 is a direction along the rotation central axis 30. The rotor 31 has a bottomed cylindrical shape having a cylindrical part 311 and a bottom wall 312 and is disposed such that the bottom wall 312 faces the inflow port 23. The rotor 31 includes a boss 313 protruding from a center part of the bottom wall 312 to an opposite side from the inflow port 23. The boss 313 is circularly annular.

The plurality of blades 32 are disposed between the rotor 31 and the fan housing 33 and rotate together with the rotor 31. The plurality of blades 32 are connected to the rotor 31 and protrude from an outer circumferential surface (side surface) 316 of the rotor 31 toward an inner circumferential surface 333 of the fan housing 33. Thus, the plurality of blades 32 protrude from the outer circumferential surface 316 of the rotor 31 toward the inner circumferential surface 27 of the tube body 2. When viewed in the axial direction D3 of the fan 3, the plurality of blades 32 radially protrude from the rotor 31 as shown in FIG. 3A. Each of the plurality of blades 32 is disposed such that a gap is formed between each blade 32 and the inner circumferential surface 333 of the fan housing 33 when viewed in the axial direction D3 of the fan 3. In other words, the fan 3 has a gap between each of the plurality of blades 32 and the inner circumferential surface 333 of the fan housing 33. The plurality of blades 32 are disposed at equal intervals when viewed in the axial direction D3 of the fan 3. The expression “equal intervals” used herein is not limited to being exactly the same intervals but may mean, for example, intervals within a predetermined error range with respect to a predetermined interval (e.g., predetermined interval ±10%). Of each of the plurality of blades 32, a first end 321 (see FIG. 3A) facing the inflow port 23 is located forward of a second end 322 (see FIG. 3A) at the side of the outflow port 24 in a rotation direction R1 (see FIG. 3A) of the rotor 31 of the fan 3.

The fan housing 33 houses the rotor 31 and the plurality of blades 32 such that the rotor 31 and the plurality of blades 32 are rotatable. The fan housing 33 is cylindrical. The fan housing 33 has an outer diameter substantially equal to an inner diameter of the tube body 2. In the fan 3, for example, the fan housing 33 is fixed to the tube body 2.

The motor 36 drives rotation of the rotor 31. More specifically, the motor 36 rotates the rotor 31 around the rotation central axis 30 (see FIGS. 2 and 3A) of the rotor 31. The motor 36 is, for example, a direct-current motor. The motor 36 is driven by the drive circuit described above. As shown in FIG. 2, the motor 36 includes a motor body 361 and a rotary shaft 362 partially protruding from the motor body 361. In the motor 36, the rotary shaft 362 is coupled to the rotor 31. The rotary shaft 362 of the motor 36 is fixed to the boss 313 of the rotor 31.

To the motor attachment, the motor body 361 of the motor 36 is attached. When viewed in the axial direction D3 of the fan 3, the motor attachment is located on an inner side of the outer edge of the rotor 31, but this should not be construed as limiting. For example, when viewed in the axial direction D3 of the fan 3, the entirety of the motor attachment may overlap the entirety of the rotor 31.

The plurality of (e.g., three) beams connect the motor attachment to the fan housing 33. The plurality of beams are disposed at equal intervals in a direction along an outer edge of the motor attachment.

As shown in FIG. 2, the first rectifying device 4 is located between the fan 3 and the outflow port 24 in the axial direction D3 of the fan 3. The first rectifying device 4 redirects the airflow F1 (see FIG. 3A) swirling on the downstream side of the fan 3. More specifically, the first rectifying device 4 changes the direction of the airflow F1 swirling on the downstream side of the fan 3 to a direction of an airflow F2 (see FIG. 3B) toward the central axis 40 of the tube part 41, which will be described later, of the first rectifying device 4. Moreover, the first rectifying device 4 forms a flow velocity distribution such that the velocity of an airflow in a first region is higher than the velocity of an airflow in a second region on the downstream side of the first rectifying device 4 when viewed in the axial direction D3 of the fan 3. Here, the velocity of the airflow is a velocity in a direction along the axial direction D3 of the fan 3. The first region is a region (inner region) which is between the central axis 20 of the tube body 2 and the inner circumferential surface 27 of the tube body 2 and which is closer to the central axis 20 than to the inner circumferential surface 27. The second region is a region (outer region) which is between the central axis 20 of the tube body 2 and the inner circumferential surface 27 of the tube body 2 and which is closer to the inner circumferential surface 27 than to the central axis 20.

The first rectifying device 4 includes the tube part 41 which is cylindrical and the plurality of (e.g., twelve) fins 42.

The tube part 41 has an outer diameter which is substantially equal to the inner diameter of the tube body 2. The tube part 41 has an inner diameter substantially equal to an inner diameter of the fan housing 33.

As shown in FIG. 3, each of the plurality of fins 42 has an arc shape when viewed in the axial direction D3 of the fan 3. The plurality of fins 42 protrude from the inner circumferential surface 413 of the tube part 41 toward the central axis 40 of the tube part 41 and are aligned in the direction along the inner circumference of the tube part 41. As shown in FIG. 2, each of the plurality of fins 42 has a first end 421 at the side of the inflow port 23 and a second end 422 at the side of the outflow port 24 in the axial direction D3 of the fan 3.

Each of the plurality of fins 42 is disposed between the inner circumferential surface 413 of the tube part 41 and the central axis 40 of the tube part 41 and is parallel to the axial direction D3 of the fan 3. In each of the plurality of fins 42, the first end 421 and the second end 422 overlap each other when viewed in the axial direction D3 of the fan 3.

The plurality of fins 42 have ends facing the tube part 41 and disposed at equal intervals in the direction along the inner circumference of the tube part 41. The expression “equal intervals” used herein is not limited to being exactly the same intervals but may mean, for example, intervals within a predetermined error range with respect to a predetermined interval (e.g., predetermined interval ±10%). The first rectifying device 4 includes a plurality of (e.g., twelve) flow paths 45 each surrounded by two adjacent fins 42 of the plurality of fins 42 and the tube part 41. When viewed in the axial direction D3 of the fan 3, each flow path 45 has a width in the direction along the inner circumference of the tube part 41, and the width narrows from the inner circumferential surface 413 of the tube part 41 toward the central axis 40 of the tube part 41 as shown in FIG. 3B.

In the axial direction D3 of the fan 3, each of the plurality of fins 42 has a length equal to a length of the tube part 41 as shown in FIG. 2. The length of each of the plurality of fins 42 is not limited to being equal to the length of the tube part 41 but may be longer than, or shorter than, the length of the tube part 41.

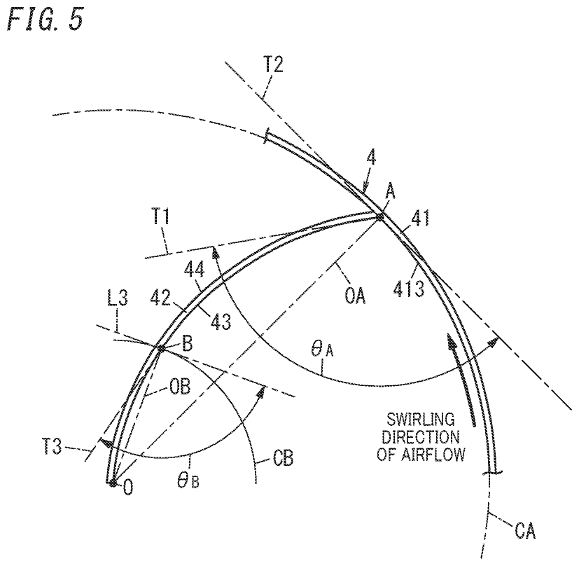

As shown in FIG. 5, each of the plurality of fins 42 has a first surface 43 intersecting a direction along an inner circumference of the tube body 2 and a second surface 44 intersecting the direction along the inner circumference of the tube body 2 and on an opposite side from the first surface 43. The first surface 43 is a surface located rearward in a direction along the rotation direction R1 of the rotor 31. The second surface 44 is a surface located frontward in the direction along the rotation direction R1 of the rotor 31. The first surface 43 is a concavely curved surface. The second surface 44 is a convexly curved surface.

As shown in FIG. 5, the first surface 43 of each of the plurality of fins 42 has an end point A facing the inner circumferential surface 413 of the tube part 41 and an end point O on an opposite side from the inner circumferential surface 413 of the tube part 41 when viewed in the axial direction D3. On the first surface 43 of each of the plurality of fins 42, an angle θ_{A} of greater than 90 degrees (π/2 radian) is formed between a half-line which is part of a tangent line T1 at the end point A of a circular arc connecting the end point O and the end point A to each other and which extends from the end point A toward an inner side of the tube part 41 and a half-line which is part of a tangent line T2 at the end point A of a circular arc CA having a center at the end point O and a radius set to a line segment OA bounded by the end point O and the end point A and which extends from the end point A toward an opposite side from the second surface 44 when viewed in the axial direction D3 of the fan 3. On the first surface 43 of each of the plurality of fins 42, an angle θ_{B} of greater than 90 degrees (π/2 radian) is formed between a half-line which is part of a straight line L3 orthogonal to a line segment OB bounded by the end point O on the opposite side from the inner circumferential surface 413 of the tube part 41 and an arbitrary point B on the fin 42 and which extends from the arbitrary point B toward the opposite side from the second surface 44 and a half-line which is part of a tangent line T3 at the arbitrary point B and which extends from the arbitrary point B toward the end point O when viewed in the axial direction D3 of the fan 3. The straight line L3 corresponds to a tangent line at the arbitrary point B of a circular arc CB having a center at the end point O and a radius set to the line segment OB bounded by the end point O and the arbitrary point B.

A material for the first rectifying device 4 is, but not limited to, metal, and may be a resin.

As shown in FIG. 2, the second rectifying device 5 is located between the first rectifying device 4 and the outflow port 24 of the tube body 2 in the axial direction D3 of the fan 3. The second rectifying device 5 adjusts the flow velocity distribution of an airflow from the first rectifying device 4 on the downstream side of the first rectifying device 4. The second rectifying device 5 includes the plurality of flow paths 55 along the axial direction D3 of the fan 3. Each of the plurality of flow paths 55 has an entrance 551 facing the first rectifying device 4 and an exit 552 facing the outflow port 24 of the tube body 2. In each of the plurality of flow paths 55, the entrance 551 and the exit 552 have the same shape. In each of the plurality of flow paths 55, the entrance 551 and the exit 552 have the same size. The second rectifying device 5 includes a rectifying grid 50 and a tube part 51 which surrounds the rectifying grid 50 and which is cylindrical. The rectifying grid 50 includes a plurality of partition plates 56 partitioning arbitrary two adjacent flow paths 55 of the plurality of flow paths 55. Each of the plurality of partition plates 56 is disposed along the axial direction D3 of the fan 3. The rectifying grid 50 is in the shape of a honeycomb grid. Here, when viewed in the axial direction D3 of the fan 3, the entrance 551 and the exit 552 of each of the plurality of flow paths 55 each have a regular hexagonal shape. In another perspective, each of the plurality of flow paths 55 has a hexagonal prism shape.

The tube part 51 has an outer diameter substantially equal to the inner diameter of the tube body 2. As shown in FIG. 2, the second rectifying device 5 is disposed in the tube body 2 such that the central axis of the tube part 51 coincides with the central axis 20 of the tube body 2.

A material for the second rectifying device 5 is, but not limited to, a resin, and may be, for example, metal.

### (3) Operation of Airflow Control System

In the airflow control system 1 according to the first embodiment, the rotor 31 and the plurality of blades 32 of the fan 3 rotate in the rotation direction R1 (see FIG. 3A) which is predetermined, and thereby, air at the side of the inflow port 23 of the tube body 2 (see FIG. 2) is sucked into the fan 3, and on the downstream side of the fan 3 in the tube body 2, the airflow F1 (see FIG. 3A) swirling along the inner circumferential surface 27 of the tube body 2 is generated in the tube body 2. The airflow F1 which swirls is a helically rotating three-dimensional airflow.

In the airflow control system 1, the airflow F1 (see FIG. 3A) generated on the downstream side of the fan 3 and swirling, near the inner circumferential surface 27 of the tube body 2, along the inner circumferential surface 27 is redirected, in the first rectifying device 4, to a direction toward the central axis 40 (see FIG. 3B) of the first rectifying device 4. More specifically, in the first rectifying device 4, the airflow F1 (see FIG. 3A) swirling along the inner circumferential surface 27 of the tube body 2 collides with the fins 42, and thereby, the direction of the airflow F1 is changed to a direction of the airflow F2 (see FIG. 3B) toward the central axis 40 of the first rectifying device 4. In other words, the first rectifying device 4 collects the airflow F1 generated by the fan 3 and swirling along the inner circumferential surface 27 of the tube body 2 at the side of the central axis 40 of the first rectifying device 4 and thus forms a flow velocity distribution such that the velocity of an airflow in the first region is higher than the velocity of an airflow in the second region on the downstream side of the first rectifying device 4. In sum, the airflow control system 1 can form, by using the first rectifying device 4, a velocity distribution such that the velocity of the airflow on the inner side is relatively high and the velocity of the airflow on the outer side is relatively low. Here, the velocity of the airflow is a velocity in a direction along the axial direction D3 of the fan 3. The first region is a region (inner region) which is between the central axis 20 of the tube body 2 and the inner circumferential surface 27 of the tube body 2 and which is close to the central axis 20. The second region is a region (outer region) which is between the central axis 20 of the tube body 2 and the inner circumferential surface 27 of the tube body 2 and which is close to the inner circumferential surface 27.

In the airflow control system 1, the second rectifying device 5 (see FIG. 2) on the downstream side of the first rectifying device 4 rectifies the direction of the airflow from the first rectifying device 4 in a direction along the axial direction D3 of the fan 3.

In the airflow control system 1, an airflow rectified by the second rectifying device 5 flows out through the outflow port 24 of the tube body 2.

When the fan 3 in the airflow control system 1 is driven, an airflow flowing to the downstream side of the fan 3 is rectified by the first rectifying device 4 and the second rectifying device 5 and is then spouted from the outflow port 24 of the tube body 2.

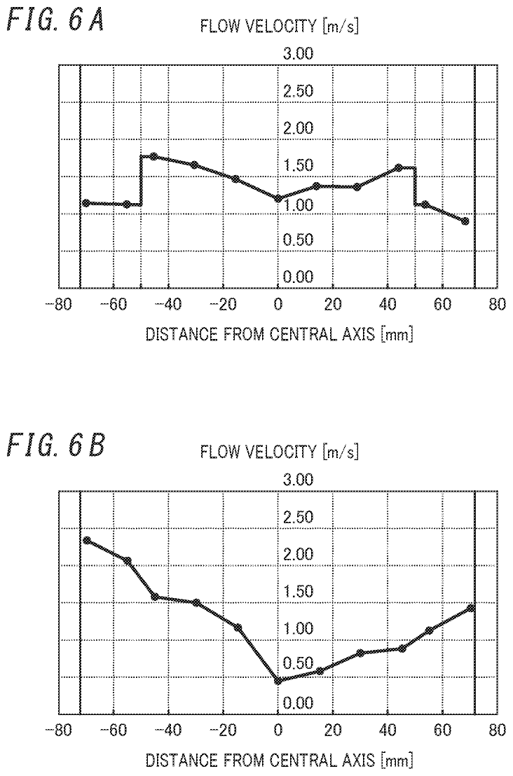

FIG. 6A shows a flow velocity distribution in the periphery of the outflow port 24 of the tube body 2 of the airflow control system 1 according to the first embodiment. FIG. 6A shows the flow velocity distribution in the airflow control system 1 according to the first embodiment when, as one example, the air volume of the fan 3 is 70 m³/h and the structure parameter is set as described below. Moreover, FIG. 6B shows a flow velocity distribution in an airflow control system of a comparative example including neither the first rectifying device 4 nor the second rectifying device 5 in the one example explained above.

### Structure Parameter

The inner diameter of the tube body 2: 144 mm.
The number of fins 42 of the first rectifying device 4: 12.
The length of each fin 42 in the axial direction D3 of the fan 3: 50 mm.
The entrance 551 of each of the flow paths 55 in the second rectifying device 5: regular hexagon having an opposite side distance of 8 mm.
The exit 552 of each of the flow paths 55 in the second rectifying device 5: regular hexagon having an opposite side distance of 8 mm.
The length of each of the flow paths 55 in the second rectifying device 5: 30 mm

Each of FIGS. 6A and 6B shows the flow velocity distribution at a cross section including the central axis 20 of the tube body 2. In each of FIGS. 6A and 6B, the abscissa represents the distance of the tube body 2 from the central axis 20, and the ordinate represents the flow velocity. The abscissa is “positive” on the right side of the central axis 20 as the center and “negative (− sign)” on the left side of the central axis 20 as the center, and “positive” and “negative (− sign)” are signs given to distinguish a distance to an arbitrary location on the right side and a distance to an arbitrary location on the left side from each other with respect to the location of the central axis 20.

In the airflow control system according to the comparative example, the flow velocity increases as the distance from the center of the outflow port 24 increases as shown in FIG. 6B. In the airflow control system 1 according to the first embodiment, a flow velocity distribution can be achieved such that the flow velocity in the inner region is higher than the flow velocity in the outer region of the outflow port 24 as shown in FIG. 6A in contrast to the comparative example. The airflow control system 1 according to the first embodiment can spout double jet streams including a first jet stream spouted from the inner region of the outflow port 24 and a second jet stream spouted from the outer region of the outflow port 24.

### (4) Effects

The airflow control system 1 according to the first embodiment includes the tube body 2, the fan 3, the first rectifying device 4, and the second rectifying device 5. The tube body 2 is cylindrical. The tube body 2 has the first end 21 provided with the inflow port 23 for gas and the second end 22 provided with the outflow port 24 for gas. The fan 3 is disposed on the inner side of the tube body 2. The first rectifying device 4 is located between the fan 3 and the outflow port 24 in the axial direction D3 of the fan 3 and configured to redirect the airflow F1 which is swirling. The second rectifying device 5 is located between the first rectifying device 4 and the outflow port 24 in the axial direction D3 and is configured to align the direction of the airflow with a direction along the axial direction (D3). The first rectifying device 4 includes the tube part 41 which is cylindrical and the plurality of fins 42. Each of the plurality of fins 42 has an arc shape. The plurality of fins 42 protrude from the inner circumferential surface 413 of the tube part 41 toward the central axis 40 of the tube part 41 and are aligned in the direction along the inner circumference of the tube part 41. The second rectifying device 5 includes the plurality of flow paths 55 along the axial direction D3.

The airflow control system 1 according to the first embodiment enables the airflow to be suppressed from diffusing. More specifically, the airflow control system 1 can enhance the directionality of the airflow (jet stream) spouted through the outflow port 24 of the tube body 2 and can suppress the airflow from diffusing. Thus, the airflow control system 1 can convey the airflow to a specific area like a spot (locally) in the target space.

### Second Embodiment

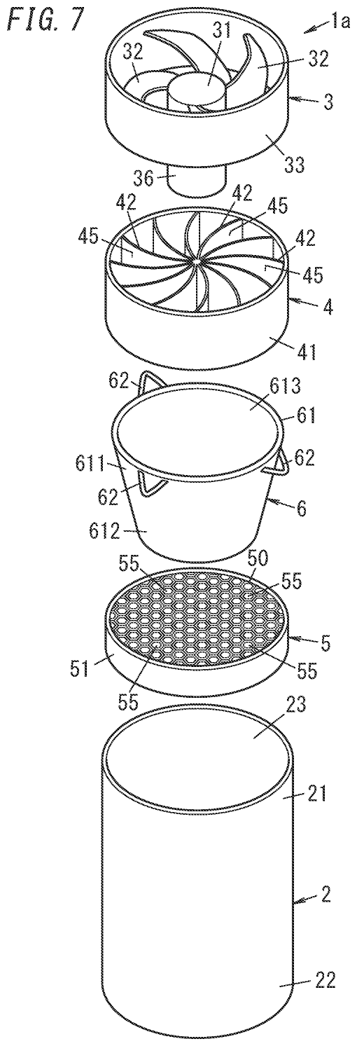

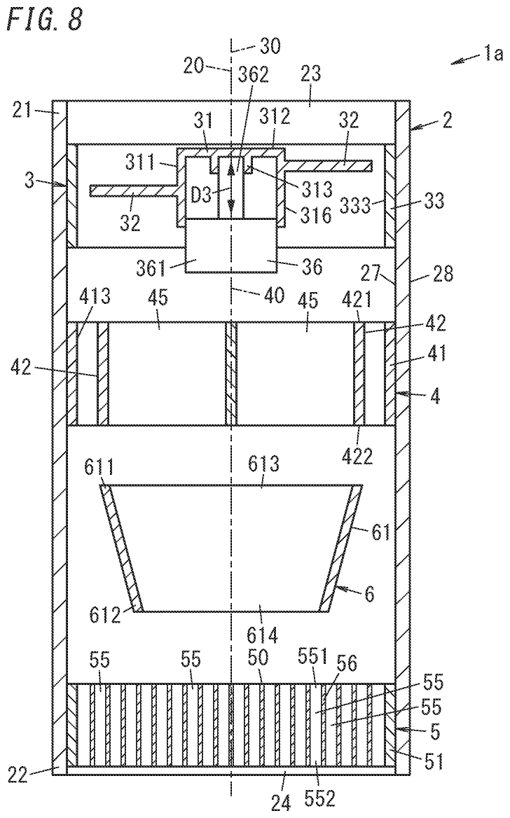

With reference to FIGS. 7 and 8, an airflow control system 1a according to a second embodiment will be described below. The airflow control system 1a according to the second embodiment is different from the airflow control system 1 according to the first embodiment in that the airflow control system 1a further includes a third rectifying device 6. Regarding the airflow control system 1a according to the second embodiment, components similar to those in the airflow control system 1 according to the first embodiment are denoted by the same reference signs as those in the first embodiment, and the description thereof will be omitted.

The third rectifying device 6 is located between a first rectifying device 4 and a second rectifying device 5 in an axial direction D3 (see FIG. 8) of a fan 3. The third rectifying device 6 includes an inner tube body 61. The inner tube body 61 has a first end 611 and a second end 612. The inner tube body 61 has an entrance 613 having a circular shape at the first end 611 and an exit 614 (see FIG. 8) having a circular shape at the second end 612. The exit 614 has a diameter smaller than a diameter of the entrance 613. The inner tube body 61 has an outer diameter smaller than an inner diameter of a tube body 2. Thus, the inner tube body 61 has a flow path sectional area smaller than a flow path sectional area of the tube body 2. The inner tube body 61 has an inner diameter and the outer diameter decreasing from the entrance 613 toward the exit 614 in the axial direction D3 of the fan 3. The inner tube body 61 is disposed, on an inner side of the tube body 2, coaxially with the tube body 2 such that the entrance 613 is located to face the first rectifying device 4 and the exit 614 is located to face the second rectifying device 5 in the axial direction D3 of the fan 3. A material for the inner tube body 61 is, for example, metal or a resin, but this should not be construed as limiting. Note that the third rectifying device 6 includes a plurality of attachments 62 for attaching the inner tube body 61 to the tube body 2.

The third rectifying device 6 functions as a diaphragm which rectifies an airflow such that on a downstream side of the first rectifying device 4, the velocity of the airflow in a first region is further increased and the velocity of the airflow in a second region is further reduced. The first region is a region (inner region) close to a central axis 20 of the tube body 2 of the central axis 20 and an inner circumferential surface 27 of the tube body 2. The second region is a region (outer region) close to the inner circumferential surface 27 of the central axis 20 of the tube body 2 and the inner circumferential surface 27 of the tube body 2.

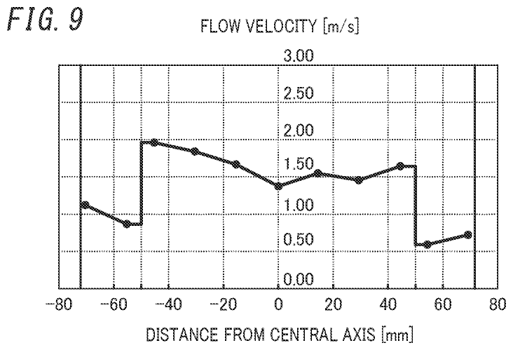

FIG. 9 shows a flow velocity distribution in the periphery of an outflow port 24 of the tube body 2 of the airflow control system 1a according to the second embodiment when, as an example, the air volume of the fan 3 is 70 m³/h and a structure parameter is set as described below. How FIG. 9 is to be seen is the same as how FIGS. 6A and 6B are seen.

### Structure Parameter

The inner diameter of the tube body 2: 144 mm.
The number of fins 42 of the first rectifying device 4: 12.
The length of each fin 42 in the axial direction D3 of the fan 3: 50 mm
An entrance 551 of each of flow paths 55 in the second rectifying device 5: regular hexagon having an opposite side distance of 8 mm
An exit 552 of each of the flow paths 55 in the second rectifying device 5: regular hexagon having an opposite side distance of 8 mm.
The length of each of t flow paths 55 in the second rectifying device 5: 30 mm.
The diameter (inner diameter) of the entrance 613 of the inner tube body 61 in the third rectifying device 6: 114 mm.
The diameter (inner diameter) of the exit 614 of the inner tube body 61 in the third rectifying device 6: 100 mm.
The length of the inner tube body 61 in the third rectifying device 6: 70 mm

A result of comparison between FIG. 9 and FIG. 6A shows that the airflow control system 1a according to the second embodiment can increase the flow velocity in an inner region while reducing the flow velocity in an outer region of the outflow port 24 and can thus increase a difference between the flow velocity in the inner region and the flow velocity in the outer region as compared with the airflow control system 1 according to the first embodiment.

The airflow control system 1a according to the second embodiment can further suppress the airflow from diffusing as compared with the airflow control system 1 according to the first embodiment. More specifically, the airflow control system 1a can further enhance the directionality of an airflow (jet stream) spouted from the outflow port 24 of the tube body 2 and can thus further suppress the airflow from diffusing.

### Third Embodiment

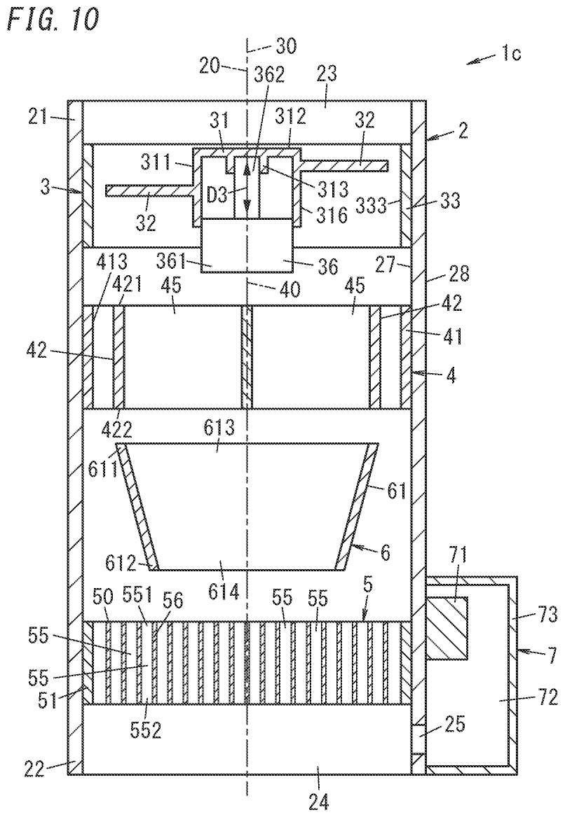

With reference to FIG. 10, an airflow control system 1c according to a third embodiment will be escribed below. The airflow control system 1c according to the third embodiment is different from the airflow control system 1a according to the second embodiment in that the airflow control system 1c further include a supply system 7. Regarding the airflow control system 1c according to the third embodiment, components similar to those of the airflow control system 1a according to the second embodiment are denoted by the same reference signs as those in the second embodiment, and the description thereof will be omitted.

The supply system 7 is a system configured to supply a functional component to be distributed into air to an airflow to be spouted from an outflow port 24. The supply system 7 includes a generation device 71 and a functional component conveying flow path 72. The generation device 71 generates, for example, mist including the functional component. The functional component conveying flow path 72 is communicated with a space between a second rectifying device 5 and the outflow port 24 at a second end 22 of a tube body 2. Examples of the functional component include an odor eliminating component, an aromatic component, an antiseptic component, a germicidal component, a beauty component, and a medical component.

The generation device 71 includes: an atomizing part configured to atomize, for example, a solution including the functional component; and an energy supplying device configured to give energy to the solution to atomize the solution at the atomizing part. The energy supplying device is, for example, but not limited to, an ultrasonic vibrator and may be a Surface Acoustic Wave (SAW) device.

In the airflow control system 1c, the tube body 2 has a communicative hole 25 penetrating through the second end 22 in a direction intersecting a central axis 20 of the tube body 2. The functional component conveying flow path 72 is communicated with the outflow port 24 of the tube body 2 via the communicative hole 25. The functional component conveying flow path 72 is formed by, for example, attaching a flow path forming member 73 to the tube body 2. The functional component conveying flow path 72 is formed between the flow path forming member 73 and an outer circumferential surface 28 of the tube body 2 and is communicated with a space in the tube body 2 via the communicative hole 25 in the tube body 2.

The supply system 7 supplies the mist including the functional component n generated by the generation device 71 via the functional component conveying flow path 72 and the communicative hole 25 to the airflow to be spouted through the outflow port 24. The supply system 7 may be configured such that the mist including the functional component is drawn in the airflow in the tube body 2 and the mist including the functional component may thus be conveyed into the tube body 2, or the supply system 7 may include a fan which sends the mist including the functional component into the tube body 2.

The supply system 7 is controlled by, for example, the control device explained in the first embodiment. In the airflow control system 1c according to the third embodiment, the control device also controls the supply system 7. The control device controls a fan 3 and the supply system 7, thereby supplying the functional component to be diffused into air to the airflow to be spouted from the outflow port 24. Examples of the controlling of the supply system 7 by the control device include starting atomization of the solution by the generation device 71, stopping the atomization of the solution, and controlling the amount of atomization of the solution.

The functional component may be charged water particles including OH radicals. In this case, the generation device 71 may be, for example, an electrostatic atomizer configured to generate charged water particles including OH radicals. The charged water particles are fine particle ions of nanometer size. The electrostatic atomizer is configured to, for example, apply a high voltage to water in air to generate fine particle ions having a particle size of from 5 nm to 20 nm. In the charged water particles, the OH radicals readily act on various substances.

The control device may control the fan 3 and the supply system 7 on the basis of, for example, information acquired from a sensor. Examples of the controlling of the fan 3 include starting operation of the fan 3 and stopping the operation of the fan 3 and may include controlling of the rotational velocity of a motor 36 of the fan 3. Examples of the sensor include an image sensor, a motion sensor, an ultrasonic sensor, a Doppler sensor, a radio wave sensor, a biological information sensor, a behavior sensor, and an environment sensor. The image sensor at least outputs information regarding an object (e.g., a person) present in a target space. Examples of the image sensor include an infrared image sensor, a Complementary MOS (CMOS) image sensor, a Charge Coupled Device (CCD) image sensor, and a distance image sensor in which a distance is set to a pixel value. As the biological information sensor, for example, a wearable terminal configured to measure at least the heart rate may be used. Examples of the wearable terminal configured to measure at least the heart rate include a wrist band-type or watch-type wearable terminal to be worn on a wrist of a person who enters and exits the target space. The behavior sensor may be constituted by, for example, a location information acquisition system. The location information acquisition system is a system which uses a transmitter carried by a person and a receiver installed at a facility to acquire location information on the transmitter. Under the condition that a person carries the transmitter, the location of the transmitter is handled as the location of the person. The transmitter has a function of transmitting a radio signal. The transmitter outputs the radio signal at a predetermined cycle. The radio signal may include identification information of the transmitter. The identification information may be used to distinguish a plurality of transmitters from each other. In the transmitter, the identification information is stored in, for example, a storage included in the transmitter. The storage is nonvolatile memory such as Electrically Erasable Programmable Read Only Memory (EEPROM). The behavior sensor is, but not limited to, a sensor which uses a location information acquisition system using a beacon. The behavior sensor may be, for example, a sensor using a Global Positioning System (GPS). Examples of the environment sensor include an odor sensor, a temperature sensor, a humidity sensor, and a CO₂ sensor.

Moreover, the control device may control at least one of the fan 3 or the supply system 7 in accordance with, for example, an operation given to an operating member (e.g., a remote controller, an operation switch) operable by the person. Further, the control device may control at least one of the fan 3 or the supply system 7 in accordance with, for example, an output of an AI loudspeaker or the like which receives a voice input by a person. Furthermore, the control device may control at least one of the fan 3 or the supply system 7 on the basis of voice of, for example, a conversation between people in the target region.

The airflow control system 1c according to the third embodiment enables the airflow to be suppressed from diffusing as the airflow control system 1a according to the second embodiment, which thus makes it possible to suppress the airflow including the functional component from diffusing. The airflow control system 1c enables a functional component to be incorporated into an airflow to be spouted into a target space in a facility and the airflow including the functional component to be suppressed from diffusing in the target space. As used herein, “to suppress the airflow including the functional component from diffusing” means to enhance the property of straightness of the airflow including the functional component to enhance the directionality. In the airflow control system 1c according to the third embodiment, a decrease in the concentration of the functional component before the functional component arrives at the space where the object to be supplied with the functional component is present can be suppressed, thereby enhancing the effect by the functional component.

### Fourth Embodiment

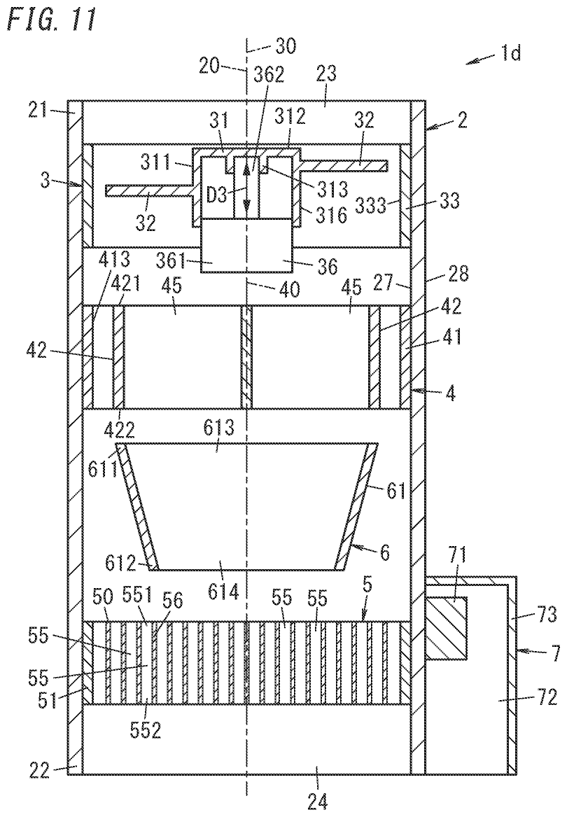

With reference to FIG. 11, an airflow control system 1d according to a fourth embodiment will be described below. The airflow control system Id according to the fourth embodiment is different from the airflow control system 1c according to the third embodiment in that the airflow control system 1d does not have the communicative hole 25 included in the tube body 2 of the airflow control system 1c (see FIG. 10) according to the third embodiment. Regarding the airflow control system 1d according to the fourth embodiment, components similar to those in the airflow control system 1c according to the third embodiment are denoted by the same reference signs as those in the third embodiment, and the description thereof will be omitted.

In the airflow control system Id according to the fourth embodiment, a functional component conveying flow path 72 is, at a second end 22 of a tube body 2, communicated with a space between a second rectifying device 5 and an outflow port 24 via an outside space on an outer side of the outflow port 24 of the tube body 2. In the airflow control system Id according to the fourth embodiment, a supply system 7 is configured such that mist including a functional component is drawn in an airflow spouted from the outflow port 24 of the tube body 2, and thereby, the mist including the functional component is conveyed to a downstream side of the outflow port 24 of the tube body 2.

The airflow control system Id according to the fourth embodiment enables the airflow to be suppressed from diffusing as the airflow control system 1c according to the third embodiment, which makes it possible to suppress the airflow including the functional component from diffusing.

### Variations

The first to fourth embodiments described above are mere examples of various embodiments of the present invention. The first to fourth embodiments may be modified in various manners depending on the design and the like without departing from the scope of the present disclosure, and different components of the embodiments different from each other may accordingly be combined with each other.

For example, each of the plurality of fins 42 is not limited to that the entirety of the first end 421 and the entirety of the second end 422 overlap each other when viewed in the axial direction D3 of the fan 3, and at least part of the first end 421 and at least part of the second end 422 at least overlap each other. Moreover, each of the plurality of fins 42 may have a configuration that the first end 421 and the second end 422 do not overlap each other when viewed in the axial direction D3 of the fan 3.

Moreover, in the second rectifying device 5, the rectifying grid 50 is not limited to being in the shape of a honeycomb grid but may be, for example, in the shape of a square grid or a triangular grid.

Moreover, the second rectifying device 5 is not limited to the rectifying grid 50 described above but may be a rectifying grid including a bundle of a plurality of (e.g., 19) narrow tubes or may be a porous plate (e.g., punching metal). Each of the plurality of narrow tubes include the flow path 55. The porous plate has a plurality of through holes constituting the plurality of flow paths 55.

Moreover, in each of the airflow control systems 1, 1a, 1c, and 1d, the tube body 2 may also serve as the fan housing 33 of the fan 3. Further, in each of the airflow control systems 1, 1a, 1c, and 1d, the tube body 2 may also serve as the tube part 41 of the first rectifying device 4. Furthermore, in each of the airflow control systems 1, 1a, 1c, and 1d, the tube body 2 may also serve as the tube part 51 of the second rectifying device 5.

Moreover, in the airflow control system 1a, the inner tube body 61 may have a constant inner diameter and a constant outer diameter in the axial direction D3 of the fan 3 and be cylindrical. Moreover, the inner tube body 61 may include a diameter reduction part at which each of the inner diameter and the outer diameter gradually changes and a cylindrical part at which each of the inner diameter and the outer diameter is constant.

Moreover, the airflow control system 1a may include a fourth rectifying device between the first rectifying device 4 and the third rectifying device 6 or between the third rectifying device 6 and the second rectifying device 5.

Moreover, in each of the airflow control systems 1, 1a, 1c, and 1d, the tube body 2 may be disposed by being embedded in a ceiling material such that the outflow port 24 of the tube body 2 faces the target space. Moreover, the tube body 2 may be attached to a wall or a stand.

Moreover, each of the airflow control systems 1, 1a, 1c, and 1d may be configured such that air from an air conditioning facility on an upstream side flows in the inflow port 23 of the tube body 2. The air conditioning facility is, for example, but not limited to, an air blower. The air conditioning facility may be, for example, a ventilating device, an air conditioner, an air supplying cabinet fan, or an air conditioning system including an air blower and a heat exchanger.

Moreover, in each of the airflow control systems 1c and 1d, the generation device 71 may include a plurality of atomizing parts configured to atomize solutions containing different functional components. In this case, each of the airflow control systems 1c and 1d controls the generation device 71 by using the control device, thereby changing the functional components supplied to the airflow to be spouted through the outflow port 24.

### Aspects

The present specification discloses the following aspects.

An airflow control system (1; 1a; 1c; 1d) of a first aspect includes a tube body (2), a fan (3), a first rectifying device (4), and a second rectifying device (5). The tube body (2) is cylindrical. The tube body (2) has a first end (21) provided with an inflow port (23) for gas and a second end (22) provided with an outflow port (24) for gas. The fan (3) is disposed on an inner side of the tube body (2). The first rectifying device (4) is located between the fan (3) and the outflow port (24) in an axial direction (D3) of the fan (3) and is configured to redirect an airflow (F1) which is swirling. The second rectifying device (5) is located between the first rectifying device (4) and the outflow port (24) in the axial direction (D3) of the fan (3) and is configured to align the direction of the airflow with a direction along the axial direction (D3) of the fan (3). The first rectifying device (4) includes a tube part (41) which is cylindrical and a plurality of fins (42). Each of the plurality of fins (42) has an arc shape. The plurality of fins (42) protrude from an inner circumferential surface (413) of the tube part (41) toward a central axis (40) of the tube part (41) and are aligned in a direction along an inner circumference of the tube part (41). The second rectifying device (5) includes a plurality of flow paths (55) along the axial direction (D3) of the fan (3).

The airflow control system (1; 1a; 1c; 1d) of the first aspect enables the airflow to be suppressed from diffusing.

In an airflow control system (1; 1a; 1c; 1d) of a second aspect referring to the first aspect, the second rectifying device (5) is a rectifying grid (50).

In an airflow control system (1; 1a; 1c; 1d) of a third aspect referring to the second aspect, the rectifying grid (50) includes a plurality of partition plates (56) each partitioning arbitrary two adjacent flow paths (55) of the plurality of flow paths (55). Each of the plurality of partition plates (56) is disposed along the axial direction (D3) of the fan (3).

The airflow control system (1; 1a; 1c; 1d) of the third aspect enables a pressure loss to be suppressed as compared with the case where a rectifying grid including a bundle of a plurality of narrow tubes or a porous plate is employed as the second rectifying device (5).

In an airflow control system (1; 1a; 1c; 1d) of a fourth aspect referring to any one of the first to third aspects, the fan (3) includes a rotor (31) and a plurality of blades (32). The rotor (31) is rotatable around a rotation central axis (30). The plurality of blades (32) are connected to the rotor (31) and are configured to rotate together with the rotor (31). Each of the plurality of fins (42) has a first surface (43) intersecting a direction along an inner circumference of the tube body (2) and a second surface (44) on an opposite side from the first surface (43). Of each of the plurality of fins (42), the first surface (43) is a concavely curved surface located rearward in a direction along a rotation direction (R1) of the rotor (31), and the second surface (44) is a convexly curved surface located frontward in the direction along the rotation direction (R1) of the rotor (31). The first surface (43) of each of the plurality of fins (42) has an angle (θ_{B}) of greater than 90 degrees between a half-line which is part of a straight line (L3) orthogonal to a line segment (OB) bounded by an end point (O) on an opposite side from the inner circumferential surface (413) of the tube part (41) and an arbitrary point (B) on the each of the plurality of fins (42) and which extends from the arbitrary point (B) toward an opposite side from the second surface (44) and a half-line which is part of a tangent line (T3) at the arbitrary point (B) and which extends from the arbitrary point (B) toward the end point (O) when viewed in the axial direction (D3).

In the airflow control system (1; 1a; 1c; 1d) of the fourth aspect, an airflow which is generated at the fan (3) and which swirls along the inner circumferential surface (27) of the tube body (2) near the inner circumferential surface (27) of the tube body (2) collides with the plurality of fins (42), and thereby, the airflow is redirected to a direction toward the central axis (40) of the tube part (41). In the airflow control system (1; 1a; 1c; 1d) of the fourth aspect, the first rectifying device (4) can, regarding a velocity distribution of the airflow to be spouted from the outflow port (24) of the tube body (2), form a velocity distribution such that the velocity of an airflow on an inner side is relatively high and the velocity of an airflow on an outer side is relatively low.

An airflow control system (1a; 1c; 1d) of a fifth aspect referring to any one of the first to fourth aspects further includes a third rectifying device (6). The third rectifying device (6) is located between the first rectifying device (4) and the second rectifying device (5) in the axial direction (D3) of the fan (3). The third rectifying device (6) includes an inner tube body (61) disposed on the inner side of the tube body (2) and coaxially with the tube body (2). The inner tube body (61) has an inner diameter and an outer diameter which decrease toward the outflow port (24) in the axial direction (D3) of the fan (3).

The airflow control system (1a; 1c; 1d) of the fifth aspect enables the airflow to be spouted through the outflow port (24) to be further suppressed from diffusing.

An airflow control system (1c; 1d) of a sixth aspect referring to any one of the first to fifth aspects further includes a supply system (7). The supply system (7) is configured to supply a functional component to be diffused into air to an airflow to be spouted from the outflow port (24).

The airflow control system (1c; 1d) of the sixth aspect enables a functional component to be incorporated into an airflow to be spouted from the outflow port (24) of the tube body (2) and the airflow including the functional component to be suppressed from diffusing.

In an airflow control system (1c; 1d) of a seventh aspect referring to the sixth aspect, the supply system (7) includes a generation device (71) and a functional component conveying flow path (72). The generation device (71) is configured to generate mist or an ion including the functional component. The functional component conveying flow path (72) is disposed at the second end (22) of the tube body (2) and is communicated with a space between the second rectifying device (5) and the outflow port (24).

The airflow control system (1c; 1d) of the seventh aspect does not have to be provided with the functional component conveying flow path (72) in the tube body (2) and thus enables the airflow in the tube body (2) to be suppressed from being disturbed by the influence of the functional component conveying flow path (72).

In an airflow control system (1; 1a; 1c; 1d) according to an eighth aspect referring to any one of the first to seventh aspects, each of the plurality of fins (42) has a first end (421) at a side of the inflow port (23) and a second end (422) at a side of the outflow port (24). Of each of the plurality of fins (42), the first end (421) and the second end (422) overlap each other when viewed in the axial direction (D3) of the fan (3).

The airflow control system (1; 1a; 1c; 1d) according to the eighth aspect readily redirects the airflow to a direction along the axial direction (D3) of the fan (3).

In an airflow control system (1; 1a; 1c; 1d) of a ninth aspect referring to any one of the first to eighth aspects, the first rectifying device (4) is disposed such that the central axis (40) of the tube part (41) coincides with a central axis (20) of the tube body (2).

In the airflow control system (1; 1a; 1c; 1d) of the ninth aspect, the airflow is readily redirected to the direction along the axial direction (D3) of the fan (3).

### REFERENCE SIGNS LIST

1, 1a, 1c, 1d Airflow Control System
2 Tube Body
20 Central Axis
21 First End
22 Second End
23 Inflow Port
24 Outflow Port
3 Fan
30 Rotation Central Axis
31 Rotor
32 Blade
4 First Rectifying Device
40 Central Axis
41 Cylindrical Part
42 Fin
421 First End
422 Second End
5 Second Rectifying Device
50 Rectifying Grid
55 Flow Path
56 Partition Plate
6 Third Rectifying Device
7 Supply System
71 Generation Device
72 Functional Component Conveying Flow Path
F1 Airflow
F2 Airflow
R1 Rotation Direction

1. An airflow control system comprising:
a tube body which is cylindrical, the tube body having a first end provided with an inflow port for gas and a second end provided with an outflow port for gas;
a fan disposed on an inner side of the tube body;
a first rectifying device located between the fan and the outflow port in an axial direction of the fan and configured to redirect an airflow which is swirling; and
a second rectifying device located between the first rectifying device and the outflow port in the axial direction of the fan and configured to align the direction of the airflow with a direction along the axial direction of the fan,
the first rectifying device including
a tube part which is cylindrical and
a plurality of fins protruding from an inner circumferential surface of the tube part toward a central axis of the tube part, the plurality of fins being aligned in a direction along an inner circumference of the tube part,
each of the plurality of fins having an arc shape,
the second rectifying device including a plurality of flow paths along the axial direction of the fan.

2. The airflow control system of claim 1, wherein
the second rectifying device is a rectifying grid.

3. The airflow control system of claim 2, wherein
the rectifying grid includes a plurality of partition plates each partitioning arbitrary two adjacent flow paths of the plurality of flow paths, and
each of the plurality of partition plates is disposed along the axial direction of the fan.

4. The airflow control system of claim 1, wherein
the fan includes
a rotor rotatable around a rotation central axis and
a plurality of blades connected to the rotor and configured to rotate together with the rotor,
each of the plurality of fins has
a first surface intersecting a direction along an inner circumference of the tube body and
a second surface on an opposite side from the first surface,
of each of the plurality of fins,
the first surface is a concavely curved surface located rearward in a direction along a rotation direction of the rotor and
the second surface is a convexly curved surface located frontward in the direction along the rotation direction of the rotor, and
the first surface of each of the plurality of fins has an angle of greater than 90 degrees between a half-line which is part of a straight line orthogonal to a line segment bounded by an end point on an opposite side from the inner circumferential surface of the tube part and an arbitrary point on the each of the plurality of fins and which extends from the arbitrary point toward an opposite side from the second surface and a half-line which is part of a tangent line at the arbitrary point and which extends from the arbitrary point toward the end point when viewed in the axial direction.

5. The airflow control system of claim 1, further comprising a third rectifying device located between the first rectifying device and the second rectifying device in the axial direction of the fan, wherein
the third rectifying device includes
an inner tube body disposed on the inner side of the tube body and coaxially with the tube body, and
the inner tube body has an inner diameter and an outer diameter which decrease toward the outflow port in the axial direction of the fan.

6. The airflow control system of claim 1, further comprising a supply system configured to supply a functional component to be diffused into air to an airflow to be spouted from the outflow port.

7. The airflow control system of claim 6, wherein
the supply system includes
a generation device configured to generate mist or an ion including the functional component and
a functional component conveying flow path disposed at the second end of the tube body and communicated with a space between the second rectifying device and the outflow port.

8. The airflow control system of claim 1, wherein
each of the plurality of fins has
a first end at a side of the inflow port and
a second end at a side of the outflow port and
of each of the plurality of fins,
the first end and the second end overlap each other when viewed in the axial direction of the fan.

9. The airflow control system of claim 1, wherein
the first rectifying device is disposed such that the central axis of the tube part coincides with a central axis of the tube body.
